(19) United States
(12) Patent Application Publication
(10) Pub. No.: US 2024/0059804 A1
(43) Pub. Date: Feb. 22, 2024

(54) CATALYST COMPONENT FOR ZIEGLER-NATTA OLEFIN POLYMERISATION CATALYST PRODUCTIVITY

(71) Applicant: SABIC GLOBAL TECHNOLOGIES B.V., Bergen op Zoom (NL)

(72) Inventors: Emad ABDEL HADI, Riyadh (SA); Abdulaziz AL-SUBHI, Thuwal (SA); Yahya Alaauddeen RAWAS, Thuwal (SA); Khalid Abdullah ALBAHILY, Thuwal (SA)

(21) Appl. No.: 18/266,988

(22) PCT Filed: Dec. 10, 2021
(86) PCT No.: PCT/EP2021/085195

§ 371 Date: Jun. 13, 2023

(30) Foreign Application Priority Data
Dec. 18, 2020 (EP) 20215549.5

(51) Int. Cl. C08F 4/656; C08F 4/02; C08F 210/02

(52) U.S. Cl. CPC C08F 4/6567; C08F 4/025; C08F 210/02

(57) ABSTRACT

Graphene oxide (GO)/silica (SiO₂) supported Ziegler-Natta (Z-N) catalysts are described. The catalyst includes a Z-N catalyst attached to a GO/SiO₂ support. The GO/SiO₂ support has a weight ratio of GO:SiO₂ of greater than 1:5 and includes least 25 mol. % oxygen (O) atoms. Methods of making the catalyst and use of the catalyst in alpha-olefin polymerisation reactions are also described.

The invention generally concerns supported Ziegler-Natta catalysts, methods of making the catalyst, and uses of the catalyst in alpha-olefin polymerisation reactions. In particular, the invention concerns a graphene oxide (GO)/silica (SiO₂) supported Ziegler-Natta (Z-N) catalyst (Z-N/GO/SiO₂). The catalyst can include a Z-N catalyst attached to a GO/SiO₂ support having a GO:SiO₂ weight ratio of greater than 1:5.

Ziegler-Natta catalysts can include an inert support material, a magnesium halide compound, a transition metal compound, an electron donor compound(s) and an organo-aluminium co-catalyst. The transition metal can have active catalytic properties and the magnesium halide compound can act as a synergist to increase the overall catalytic productivity of the transition metal. The electron donor compounds and organo-aluminium co-catalyst assist catalyzing the polymerisation of isotactic polymers. The silica support material is inactive and does not increase polymerisation reaction rates. Generally, the Ziegler-Natta catalysts are small, solid particles, but soluble forms and supported catalysts have also been used. Ziegler-Natta catalysts are especially useful for the homopolymerisation and copolymerisation ethylene, propylene, and other alpha olefins to produce films, fibers and moldings.

Ziegler-Natta catalyst supports are typically made from inert metal oxides such as silica and/or alumina. The use of graphene modified Ziegler-Natta catalysts is known. By way of example, in a review of uses of graphene as a catalyst and initiator (Progress in Polymer Science, 2017, 67:48-76), Nia discloses the use of graphene as a support for Ziegler-Natta catalysts. In these reactions the graphene exfoliated into the produced polymer, making the polymer conductive. Thus, if non-conductive polymers are desired, the use of graphene poses challenges.

Despite the currently available research on Ziegler-Natta catalysts, improved catalyst are still desired.

A invention has been made that provides a solution to at least some of the problems associated with Ziegler-Natta catalyst systems. The invention is premised on the idea of using a mixture of graphene oxide and silica (GO/SiO₂) as support material for Ziegler-Natta catalysts used of the polymerisation of alpha olefins.

In a particular aspect of the invention, GO/SiO₂ supported Ziegler-Natta (Z-N) catalyst (Z-N/GO/SiO₂) catalysts are described. A Z-N/GO/SiO₂ can include a Z-N catalyst attached to the GO/SiO₂ support. The GO/SiO₂ can have a weight ratio of GO:SiO₂ of greater than 1:5 (e.g., 1:10 to 1:50, preferably 1:20). In the context of the present invention, it is to be understood that ‘greater than 1:5’ means that the numerator of the fraction is 1, and the denominator is greater than 5. The GO/SiO₂ can have a weight ratio of GO:SiO₂ of 1:10 to 1:50.

The GO/SiO₂ support may for example have a weight ratio of GO:SiO₂ of ≤0.20. For example, GO/SiO₂ support may for example have a weight ratio of GO:SiO₂ of ≥0.02 and ≤0.10. Preferably, the weight ratio of GO:SiO₂ in the GO/SiO₂ support is ≥0.02 and ≤0.09, more preferably ≥0.03 and ≤0.09, even more preferably ≥0.03 and ≤0.08.

Use of such GO/SiO₂ ratio in a support for an ethylene polymerisation catalyst contributes to an increase in polymerisation activity in ethylene homo- and copolymerisation, whilst resulting in a polyethylene product having desirable product properties, such as desirable molecular weight, desirable molecular weight distribution, as well as desirable product appearance including desirable product colour. Also, the use of such GO/SiO₂ ratio in a support for an ethylene polymerisation catalyst allows for polymerisation at high polymerisation rates whilst not leading to excessive formation of polymer chunks in the polymerisation reactor that would require a process to be terminated prematurely to clean out the reactor.

A GO/SiO₂ ratio in the support of the catalyst that exceeds the range of the present invention, i.e. wherein the quantity of GO vs SiO₂ is higher than per the range of the invention, may lead to dark colouration of the product that is obtained from an ethylene (co)polymerisation reaction, as well as may lead to excessive polymer chunk formation. A GO/SiO₂ ratio in the support of the catalyst below the range of the present invention, i.e. wherein the quantity of GO vs SiO₂ is less than per the range of the invention, may lead to failing to achieve the productivity improvement.

The GO can include at least 25 mol. % oxygen (O) atoms (e.g., at least 30 mol. % oxygen atoms, preferably at least 35 mol. %, more preferably 37 mol. %). In some embodiments, the GO can include 25 mol. % to 50 mol. % of oxygen atoms, preferably 30 mol. % to 45 mol. % oxygen atoms, or more preferably 35 mol. % to 40 mol. % oxygen atoms. Notably, the GO is not reduced graphene oxide. The graphene oxide can be exfoliated or partially exfoliated graphene oxide. The Z-N/GO/SiO₂ catalyst can be the reaction product of GO/SiO₂, a magnesium (Mg) compound, an electron donor compound, a compound that can include titanium, zirconium, or vanadium, and a halogen compound. The Mg compound can be magnesium chloride, Mg(C₄H₉)₂, dialkyl magnesium, alkyl, alkyl′ magnesium, alkyl alkoxy magnesium, dialkoxy magnesium, chloroalkoxy magnesium, chlorohydroxy magnesium, or any combination thereof. The titanium-, zirconium-, or vanadium-containing compound can include titanium tetrachloride, titanium ethoxide, titanocene dichloride, zirconium tetrachloride, zirconium ethoxide, zirconocene dichloride, vanadium tetrachloride, vanadium ethoxide, vanadocene, or any combination thereof. In one embodiment the catalyst can also include trimethylaluminium. The halogen compound can be BCl₃, AlCl₃, SiCl₄, or PCl₅, or any combination thereof. The electron donor compound can be an ester, ether, ketone, or mixtures thereof, preferably pentanone.

Methods of making the Z-N/GO/SiO₂ catalyst of the present invention are also described. A method of producing the supported Z-N catalyst can include mixing graphene oxide (GO) with silica (SiO₂) in a weight ratio of greater than 1:5 to form a GO/SiO₂ mixture, dispersing the GO/SiO₂ mixture in a liquid to form a dispersion. Mixing the GO and SiO₂ can include combining the GO and SiO₂ and agitating the mixture. The dispersion can be reacted with a reactant mixture of magnesium compound, an electron donor compound, a halogen compound, and a transition metal compound (e.g., a titanium-, zirconium-, or vanadium-containing compound) under conditions sufficient to produce the Z-N/GO/SiO₂ catalyst of the present invention. The reactant mixture can be obtained by solubilizing the magnesium compound, the halogen compound, the titanium-, zirconium-, or vanadium-containing compound in the electron donor compound. Reaction conditions can include a temperature of 15 to 120° C. at atmospheric pressure or slightly higher than atmospheric pressure (e.g. 0.01 MPa to 1 MPa). Reaction time can be at least 0.5 hours, or 0.5 to 24 hours or any range or value there between. The catalyst can be isolated and dried at a temperature of 25° C. to 45° C., or about 35° C. under a flow of inert gas, preferably nitrogen. The advantage of this synthesis is that is allows for the graphene oxide to be spread over silica surfaces during the catalyst synthesis, and then, during polymerisation, the dispersed graphene oxide can be easily exfoliated into the polymeric matrix.

Methods of polymerising alpha-olefins using the any of the supported Z-N catalysts of the present invention are described. A method of polymerising olefin can include contacting an activated Z-N/GO/SiO₂ catalyst, preferably the Z-N catalyst of the present invention. Activation of the Z-N/GO/SiO₂ catalyst can be occur by contacting the Z-N/GO/SiO₂ catalyst with an aluminium compound, preferably triethylaluminium. The reaction can be performed under an inert gas atmosphere. The gaseous reactant mixture can include an alpha-olefin (e.g., C1 to C12 alpha-olefins) and optional hydrogen (H₂) under conditions sufficient to polymerise the alpha-olefin. H₂ can be used to control the molecular weight of the polymer. Reaction conditions can a temperature of 25 to 35° C. and/or a pressure of about 0.01 MPa of inert gas. In some embodiments, the alpha-olefin is ethylene and the ethylene consumption is at least 50 N/hr for 60 minutes. As exemplified in a non-limiting manner in the Examples the catalyst of the present invention was 3 times more productive than a non-graphene oxide supported catalyst.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment discussed herein can be implemented with respect to any method or composition of the invention, and vice versa. Furthermore, compositions of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The catalysts and methods of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the Z-N/GO/SiO₂ catalysts of the present invention are their abilities to catalyze the polymerisation of alpha-olefins.

Advantages of the present invention may become apparent to those skilled in the art with the benefit of the following detailed description and upon reference to the accompanying drawings.

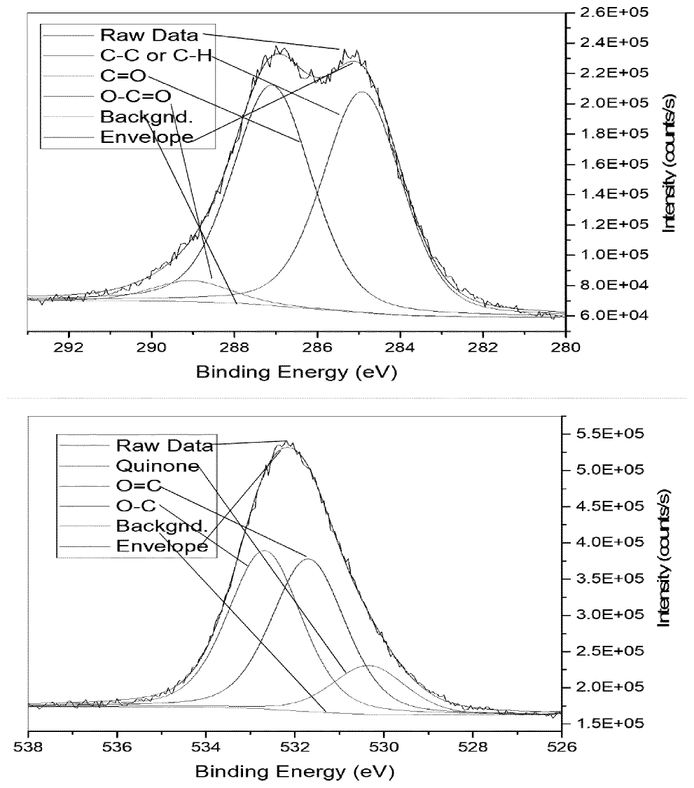

FIG. 1 depicts X-ray photoelectron spectroscopy graphs for graphene oxide used in the preparation of the catalyst of the present invention.

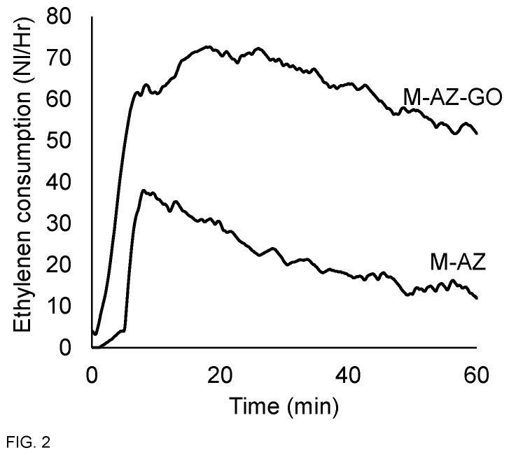

FIG. 2 is a comparison of ethylene consumption versus production time for a comparative catalyst (bottom line) and the catalyst of the present invention (top line).

While the invention is susceptible to various modifications and alternative forms, specific embodiments thereof are shown by way of example in the drawings. The drawings may not be to scale.

An invention has been made that provides a solution to some of the problems associated with Ziegler-Natta catalysis of alpha-olefins. The invention is premised in the use of a Z-N catalyst attached to a mixed graphene oxide silica oxide support material. Notably, and as exemplified in the Examples, the Z-N/GO/SiO₂ catalyst of the present invention showed three times better production than a Z-N catalyst absent graphene oxide.

These and other non-limiting aspects of the present invention are discussed in further detail in the following sections.

### A. GO/Si Supported Z-N Catalyst

The catalyst of the present invention can include a Z-N catalyst attached to a support material that includes graphene oxide and silica. The attachment can be through covalent bonding between the oxygen atoms in the support material and the metals of Z-N catalyst (e.g., Mg, Ti, V, Zr, or the like). Other types of attachment can include ionic bonding and Van der Waals interactions. The oxygen atoms in the support material can be bonded to the carbon atoms in the graphene and/or the silicon atoms of the silica material. The graphene oxide can include at least 25 wt. % of elemental oxygen (O), or at least, equal to, or between any two of 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, 41 wt. %, 42 wt. %, 43 wt. %, 44 wt. %, 45 wt. %, 46 wt. %, 47 wt. %, 48 wt. %, 49 wt. % and 50 wt. %. The GO:SiO₂ weight ratio can be at least 1:5, or at least, equal to, or between any two of 1:5, 1:10, 1:15, 1:20, 1:25, 1:30, 1:35, 1:40, 1:45, and 1:50, or about 1:5 to 1:50, 1:10 to 1:40, or about 1:20. In some embodiments, the graphene can be exfoliated or partially exfoliated.

The silica can have a specific surface area in the range of from about 10 to about 1000 m²/g, preferably of from about 50 to about 700 m²/g, and more preferably from about 100 to about 600 m²/g. Specific surface area can be determined using known standardized tests, for example, DIN 66131. The shape of the particulate silica can be of an irregular, semi-spherical, micro-spheroidal or combinations thereof. In some embodiments, the silica can be spherical and have a mean particle diameter in the range of from about 5 to about 200 micrometers, or at least, equal to, or between any two of 5, 10, 20, 30, 40, 50, 60, 70, 80, 90 and 100 micrometers. In some embodiments, fumed silica can be used.

The Z-N catalyst can be the reaction product of GO/SiO₂, a magnesium (Mg) compound, an electron donor compound, a Ti-, Zr-, or V-containing compound and a halogen compound. The Mg compound can be a magnesium halide, a dialkyl magnesium, an alkyl alkoxy magnesium, a dialkoxy magnesium, a chloroalkoxy magnesium, a chlorohydroxy magnesium, or any combination thereof. In a preferred embodiment, the magnesium compound is magnesium chloride (MgCl₂), dibutyl magnesium Mg(C₄H₉)₂, or a combination thereof.

Titanium containing compounds can include titanium tetrachloride (TiCl₄), titanium bromide (TiBr₄), titanium alkoxy (Ti(OR)₄) were R is 2 to 20 alkyl groups, titanocene dichloride or combinations thereof. Non-limiting examples of titanium alkoxy compounds include titanium tetraethoxide (Ti(OCH₂CH₃)₄), titanium triethoxidechloride (Ti(OCH₂CH₃)₃Cl), titanium di-ethoxide dichloride (Ti(OCH₂CH₃)₂Cl₂), titanium tetraisopropoxide (Ti(OPr)₄) and titanium butoxide (Ti(OBu)₄). Zirconium containing compounds can include zirconium tetrachloride (ZrCl₄), zirconium ethoxide (Zr(OCH₃)₄), zirconocene dichloride. Vanadium compounds can include vanadium tetrachloride (VCl₄), vanadium ethoxide (V(OCH₃)₄), vanadocene, or any combination thereof.

The halogen compound can be boron trichloride (BCl₃), aluminium trichloride (AlCl₃), silicon tetrachloride (SiCl₄) or phosphorous pentachloride (PCl₅), or any combination thereof.

The electron donor compound can be any electron donor known for Ziegler-Natta catalysis. The electron donor can include an amine, amide, ester, ether, ketone, nitriles, ethers, phosphines, diethers, succinates, phthalates, or dialkoxybenzenes, or mixtures thereof. In a preferred embodiment, the electron donor is pentanone. Examples of suitable electron donors include carboxylic acids, carboxylic acid anhydrides, esters of carboxylic acids, halide carboxylic acids, alcohols, ethers, ketones, amines, amides, nitriles, aldehydes, alcoholates, sulfonamides, thioethers, thioesters and other organic compounds containing a hetero atom, such as nitrogen, oxygen, sulfur, and/or phosphorus. The molar ratio of the electron donor relative to the magnesium can be between 0.05 and 0.75, or more preferably between 0.1 and 0.4.

Non-limiting examples of suitable carboxylic acids include formic acid, acetic acid, propionic acid, butyric acid, isobutanoic acid, acrylic acid, methacrylic acid, maleic acid, fumaric acid, tartaric acid, cyclohexanoic monocarboxylic acid, cis-1,2-cyclohexanoic dicarboxylic acid, phenylcarboxylic acid, toluenecarboxylic acid, naphthalene carboxylic acid, phthalic acid, isophthalic acid, terephthalic acid and/or trimellitic acid. Non-limiting examples of anhydrides include anhydrides of the above carboxylic acids such as acetic acid anhydride, butyric acid anhydride and methacrylic acid anhydride. Non-limiting examples of suitable esters of include formates, acetates, acrylates, benzoates, phthalates, or any combination thereof. Formates can include butyl formate. Acetates can include ethyl acetate and butyl acetate. Acrylates can include ethyl acrylate, methyl methacrylate and isobutyl methacrylate. Benzoates can include methylbenzoate and ethylbenzoate, methyl-p-toluate, and ethyl-D-naphthoate. Phthalates can include monomethyl phthalate, dibutyl phthalate, diisobutyl phthalate, diallyl phthalate and/or diphenyl phthalate. Non-limiting examples of suitable halide carboxylic acids can include halides of the carboxylic acids mentioned above, for instance acetyl chloride, acetyl bromide, propionyl chloride, butanoyl chloride, butanoyl iodide, benzoyl bromide, p-toluyl chloride and/or phthaloyl dichloride. Non-limiting examples of suitable alcohols can include methanol, ethanol, butanol, isobutanol, xylenol, and benzyl alcohol. Non-limiting examples of suitable ethers are diethyl ether, dibutyl ether, diisoamyl ether, anisole and ethylphenyl ether, 2,2-diisobutyl-1,3-dimethoxypropane, 2,2-dicyclopentyl-1,3-dimethoxypropane, 2-ethyl-2-butyl-1,3-dimethoxypropane, 2-isopropyl-2-isopentyl-1,3-dimethoxypropane and/or 9,9-bis(methoxymethyl)fluorene. Also, tri-ethers can be used. Non-limiting examples of other organic compounds containing a heteroatom can include 2,2,6,6-tetramethyl piperidine, 2,6-dimethylpiperidine, 2-methylpyridine, 2-acetyl-4-methylpyridine, imidazole, benzonitrile, aniline, diethylamine, dibutylamine, thiophenol, 2-methyl thiophene, isopropyl mercaptan, diethylthioether, diphenylthioether, tetrahydrofuran, dioxane, dimethylether, diethylether, anisole, acetone, triphenylphosphine, triphenylphosphite, diethylphosphate and/or diphenylphosphate.

### B. Preparation of Z-N/GO/Silica Catalyst

Methods of producing the Z-N/GO/Silica catalyst of the present invention are described. A method can include mixing GO with SiO₂ and dispersing the mixture in a liquid. The GO/SiO₂ dispersion can be reacted with the components of a Ziegler-Natta catalyst system described herein to form the Z-N/GO/SiO₂ catalyst of the present invention. The weight ratio of GO:SiO₂ can be at least 1:5, or at least, equal to, or between any two of 1:5, 1:10, 1:15, 1:20, 1:25, 1:30, 1:35, 1:40, 1:45, and 1:50, or about 1:5 to 1:50, 1:10 to 1:40, or about 1:20. Mixing can include agitating the two compounds at a slow speed (e.g., slow rate per minute). Mixing can be done at 20 to 50° C. or any value or range there between and at atmospheric or near atmospheric pressure (e.g., about 0.0101 MPa). The liquid can be a hydrocarbon solvent that is non-reactive to the Z-N catalyst. In some embodiments, the liquid can be aliphatic hydrocarbons, aromatic hydrocarbon compounds, or halogenated aromatic compounds having 4 to 20 C-atoms. Non-limiting examples of hydrocarbon solvents include pentane(s), hexane(s), cyclohexane(s) heptane(s), cycloheptane(s), toluene, xylene, benzene, heptane and chlorobenzene, and the like. To the GO/SiO₂ dispersion the magnesium compound, the electron donor compound, the halogen compound, the titanium, zirconium or vanadium compound are added sequentially in the order listed. The reaction mixture can be agitated until formation of the catalyst is complete (e.g., from 1 hour to 24 hours, or 1, 2, 3, 5, 10, 15, 20, and 24 hours, or any range or value there between). A mole ratio of Mg compound to halogen compound can be 2:1 to 10:1, or about 1:4. A mole ratio of Mg to electron donor can be 0.5:20 to 1:10, or about 1:2. A mole ratio of total titanium compound can be 0.1:10 to 1:10, or about 2.6:1. In a preferred embodiments, 1 to 4 or about 2 mmol Mg(Bu)₂, 1 to 10 or about 4 mmol pentanone, 0.1 to 1 or about 0.5 mmol SiCl₄, 0.1 to 1 or about 0.25 mmol Ti(OEt)₄, and 0.1 to 1 or about 0.5 mmol TiCl₄ can be added to the GO/SiO₂ dispersion.

Reaction conditions can include a temperature of 15 to 120° C., or 20 to 100° C., 30 to 70° C., or at least, equal to, or between any two of 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 115° C., and 120° C. In some embodiments, the magnesium compound, the halogen compound, and the Ti-, Zr-, V-containing compound can be solubilized in the electron donor compound. The catalyst can be isolated from the solvent using known catalyst isolation techniques (e.g., filtration, centrifugation, etc.). After isolation, the Z-N/GO/SiO₂ catalyst can be dried at 25 to 45° C., or at least, equal to, or between any two of 25° C., 30° C., 35° C., 40° C., and 45° C. under a flow of inert gas (e.g., nitrogen).

### C. Use of the Z-N/GO/Silica Catalyst

The Z-N/GO/SiO₂ catalyst can be used in an alpha-olefin polymerisation reaction. In some embodiments, a co-catalyst and/or scavenger compound can be added to the reaction media. The co-catalyst can include an aluminium alkyl compound. Non-limiting examples of an aluminium alkyl compounds include trimethylaluminium, triisobutyl aluminium, triethyl aluminium, tri-n-octylaluminium, n-octyl aluminium, n-hexyl aluminium, or any combination thereof. A Al:Ti-, Zr-, V-containing compound molar ratio can be form 20:1 to 300:1 or 30:1 to 200:1 or any range or value there between.

The polymerisation can be carried out in continuous mode or batch wise. Slurry-, bulk-, and gas-phase polymerisation processes, multistage processes of each of these types of polymerisation processes, or combinations of the different types of polymerisation processes in a multistage process are contemplated herein. Preferably the polymerisation process is a single stage gas phase process or a multistage, for instance a 2-stage, gas phase process where in each stage a gas-phase process is used. Examples of gas-phase polymerisation processes include both stirred bed reactors and fluidized bed reactor systems; such processes are well known in the art. Typical gas phase α-olefin polymerisation reactor systems can include a reactor vessel to which α-olefin monomer(s) and a catalyst system can be added and which contain an agitated bed of forming polymer particles. Optionally, hydrogen may be added to the process, such as for molecular weight control of the resultant polymer.

In the case of polymerisation in the liquid phase a dispersing agent can be present. Suitable dispersing agents include for instance n-butane, isobutane, n-pentane, isopentane, hexane, heptane, octane, cyclohexane, benzene, toluene, xylene and liquid propylene. The polymerisation temperature can be 0° C. to 120° C., preferably between 25° C. and 35° C. The polymerisation time can vary, for example, 1-10 hours, preferably between 2.5 to 3.5 hours. The pressure during the polymerisation can be 0.1 and 6 MPa, preferably between 0.5 to 3 MPa.

In one non-limiting example a dispersion of Z-N/GO/SiO₂ and a co-catalyst and/or scavenger can be added to a solvent in a polymerisation unit. A feed stream of alpha-olefin (ethylene gas) can enter the polymerisation unit with optional hydrogen gas. The suspension (which may include diluents) may be intermittently or continuously removed from the reactor where the volatile components can be separated from the polymer and recycled, optionally after a distillation, to the reactor. In some embodiments, the ethylene consumption can be at least 50 N/hr for 60 minutes.

The polymers (and blends thereof) formed using the catalysts of the present invention can include linear low density polyethylenes, elastomers, plastomers, high density polyethylenes, low density polyethylenes, medium density polyethylenes, polypropylenes, polypropylene copolymers, and the like.

Accordingly, the invention relates to a graphene oxide (GO)/silica (SiO₂) supported Ziegler-Natta (Z-N) catalyst (Z-N/GO/SiO₂), the catalyst comprising a Z-N catalyst attached to a GO/SiO₂ support, wherein the GO/SiO₂ support has a weight ratio of GO:SiO₂ of greater than 1:5, and the GO comprises at least 25 mol. % oxygen (O) atoms.

It is preferred that in the supported Z-N catalyst, the GO:SiO₂ weight ratio is between 1:10 to 1:50, preferably 1:20.

The GO may for example comprise 25 mol. % to 50 mol. % of oxygen atoms, preferably 30 mol. % to 45 mol. % oxygen atoms, or more preferably 35 mol. % to 40 mol. % oxygen atoms, or wherein the GO comprises at least 30 mol. % oxygen atoms, preferably at least 35 mol. %, more preferably 37 mol. %.

Preferably, the Z-N/GO/SiO₂ catalyst is the reaction product of GO/SiO₂, a magnesium (Mg) compound, an electron donor compound, a compound comprising titanium, zirconium, or vanadium, and a halogen compound.

The Mg compound may for example be magnesium chloride, Mg(C₄He)₂, dialkyl magnesium, alkyl, alkyl′ magnesium, alkyl alkoxy magnesium, dialkoxy magnesium, chloroalkoxy magnesium, chlorohydroxy magnesium, or any combination thereof.

The compound comprising titanium, zirconium, or vanadium may for example be titanium tetrachloride, titanium ethoxide, titanocene dichloride, zirconium tetrachloride, zirconium ethoxide, zirconocene dichloride, vanadium tetrachloride, vanadium ethoxide, vanadocene, or any combination thereof.

It is preferred that the supported Z-N catalyst further comprises trimethylaluminum.

The halogen compound may for example be BCl₃, AlCl₃, SiCl₄ or PCl₅.

The electron donor compound may for example be an ester, ether, ketone, or mixtures thereof, preferably pentanone.

It is preferred that the graphene oxide is exfoliated or partially exfoliated graphene oxide.

In one of its embodiments, the invention also relates to a method of producing the supported Z-N catalyst, the method comprising:
(a) mixing graphene oxide (GO) with silica (SiO₂) in a weight ratio of greater than 1:5 to form a GO/SiO₂ mixture, preferably wherein mixing the GO and SiO₂ comprises combining the GO and SiO₂ and agitating the mixture;
(b) dispersing the GO/SiO₂ mixture in a liquid to form a dispersion; and
(c) reacting the dispersion with a reactant mixture of magnesium compound, an electron donor compound, a halogen compound, and a compound comprising titanium, zirconium, or vanadium under conditions sufficient to produce the Z-N/GO/SiO₂ catalyst of any of claim 1 to 10.

It is preferred that the reactions conditions comprise a temperature of 15 to 120° C. It is preferred that the reactions conditions comprise a time of 30 to 120 min. It is preferred that the reactions conditions comprise a temperature of 15 to 120° C. and a time of 30 to 120 min. It is preferred that the reactions conditions comprise a temperature of 15 to 120° C. and a time of 60 min.

It is preferred that the step (c) reactant mixture is obtained by solubilizing the magnesium compound, the halogen compound, the titanium compound in the electron donor compound.

The method further preferably comprises isolating the catalyst and drying the catalyst at 25 to 45° C., or about 35° C. under a flow of inert gas, preferably nitrogen.

The invention in a further embodiment also relates to a method of polymerising an alpha-olefin, preferably ethylene, the method comprising: contacting an activated Z-N/GO/SiO₂ catalyst with gaseous reactant mixture comprising an alpha-olefin and hydrogen (H₂) under conditions sufficient to polymerise the alpha-olefin, preferably wherein the Z-N/GO/SiO₂ catalyst is activated by contacting the Z-N/GO/SiO₂ catalyst with an aluminium compound, preferably triethylaluminium, particularly preferably wherein the Z-N/GO/SiO₂ catalyst is any one of the Z-N/GO/SiO₂ catalysts of claims 1 to 10.

In a certain embodiment, the invention relates to a graphene oxide (GO)/silica (SiO₂) supported Ziegler-Natta (Z-N) catalyst (Z-N/GO/SiO₂), the catalyst comprising a Z-N catalyst attached to a GO/SiO₂ support, wherein the GO/SiO₂ support has a weight ratio of GO:SiO₂ of 1:10 to 1:50, and the GO comprises at least 25 mol. % oxygen (O) atoms.

In a certain embodiment, the invention relates to a graphene oxide (GO)/silica (SiO₂) supported Ziegler-Natta (Z-N) catalyst (Z-N/GO/SiO₂), the catalyst comprising a Z-N catalyst attached to a GO/SiO₂ support, wherein the GO/SiO₂ support has a weight ratio of GO:SiO₂ of ≤0.20, preferably of ≥0.02 and ≤0.10, more preferably of ≥0.02 and ≤0.09, even more preferably of ≥0.03 and ≤0.09, yet even more preferably of ≥0.03 and ≤0.08, and the GO comprises at least 25 mol. % oxygen (O) atoms.

In a certain embodiment, the invention relates to a graphene oxide (GO)/silica (SiO₂) supported Ziegler-Natta (Z-N) catalyst (Z-N/GO/SiO₂), the catalyst comprising a Z-N catalyst attached to a GO/SiO₂ support, wherein the GO/SiO₂ support has a weight ratio of GO:SiO₂ of ≤0.20, preferably of ≥0.02 and ≤0.10, more preferably of ≥0.02 and ≤0.09, even more preferably of ≥0.03 and ≤0.09, yet even more preferably of ≥0.03 and ≤0.08, wherein the GO comprises 25 mol. % to 50 mol. % of oxygen atoms, preferably 30 mol. % to 45 mol. % oxygen atoms, or more preferably 35 mol. % to 40 mol. % oxygen atoms, or wherein the GO comprises at least 30 mol. % oxygen atoms, preferably at least 35 mol. %, more preferably 37 mol. %.

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1: Preparation of the Z-N/GO/SiO₂ Catalyst

Graphene oxide (50 mg,) premixed with dried silica (1 g, at a wt. ratio of 1:20). This mixture was slurried in heptane, and then treated with Mg(Bu)₂ (2 mmol), pentanone (4 mmol), SiCl₄ (0.5 mmol), Ti(OEt)₄ (0.25 mmol), and TiCl₄ (0.5 mmol). The resulting dispersion was dried at about 35° C. to remove the volatile material and to form the catalyst powder. The graphene oxide was analyzed using X-ray photon spectroscopy (XPS). Table 1 lists the composition of the graphene oxide as determined using the XPS graphs shown in FIG. 1

TABLE 1

| | | | Corrected | | | |
|---|---|---|---|---|---|---|
| Species | B.E. (eV) | Element | P.A. | At % | Total | |
| C—C, C—H | 284.9 | C | 1305059.831 | 30% | | |
| C—O | 287.1 | C | 1301193.615 | 30% | 62.98% | Carbon |
| O—C═O | 289 | C | 122503.9189 | 3% | | |
| Quinone | 530.3 | O | 216766.8776 | 5% | | |
| C═O | 531.7 | O | 681178.045 | 16% | 37.02% | Oxygen |
| C—O | 532.7 | O | 705835.3024 | 16% | | |
| Total | | | 4332537.59 | 100% | | |

### Example: Polymerisation of Ethylene Using the Z-N/GO/SiO₂ Catalyst

The catalyst of Example 1 and a comparative Ziegler-Natta catalyst not supported on graphene oxide (made using the methodology of Example 1 without the graphene) were employed for ethylene polymerisation reactions with TEAL as co-catalyst and isopentane as the media. In a 1 L reactor, charged with the catalyst, TEAL and isopentane, 3 bar H₂ gas and up to 20 bar total pressure with ethylene gas was added. The reaction was found to be 3-times more productive than the AZ catalyst that did not contain graphene oxide. Kinetic profile of the standard Ziegler-Natta catalyst compared to the GO-modified catalyst is shown in FIG. 2. The yield, bulk density, and Mw analysis results are shown in Table 2.

TABLE 2

| | Yield | B.D. | Mn | Mw | Mz | | Tm | Tc |
|---|---|---|---|---|---|---|---|---|
| Catalyst | (g) | (KgM⁻³) | (g/mol) | (g/Mol) | (g/Mol) | PDI | (° C.) | (° C.) |
| Example 1 | 93 | 360 | 42252 | 174211 | 3562627 | 4.1 | 120 | 133 |
| Comparative | 29 | 340 | 40418 | 154857 | 385613 | 3.8 | 120 | 133 |
| Catalyst | | | | | | | | |

B.D: bulk density of catalyst; Mn: Number-average molecular weight; Mw: Weight-average molecular weight; Mz: Z-average molecular weight; PDI: dispersity index; Tm—melt temperature; and Tc—crystallization temperature.
Mn, Mw, Mz and PDI were determined by gel permeation chromatography with a refractive index detector and a polystyrene standard.
TM and TC were determined using differential scanning calometry.

### Comparative Example 3: Polymerisation of Ethylene Using the Z-N/GO Catalyst

Graphene oxide (10 to 50 mg,) was slurried in heptane, and then treated with Mg(Bu)₂ (2 mmol), pentanone (4 mmol), SiCl₄ (0.5 mmol), Ti(OEt)₄ (0.25 mmol), and TiCl₄ (0.5 mmol). The resulting dispersion was dried at 25 to 60° C. to remove the volatile material and to form the comparative catalyst powder. The catalyst was evaluated as described in Example 2. The reaction was found to be extremely active, leading to a chunk or polymer in the reactor, and the reaction was terminated within 10 minutes of catalyst injection due to high torque on the stirrer and rise in temperature over 110° C. The results were duplicated and showed the same behavior. Polymers with low quality were produced using this catalyst.

1. A graphene oxide (GO)/silica (SiO₂) supported Ziegler-Natta (Z-N) catalyst (Z-N/GO/SiO₂), the catalyst comprising a Z-N catalyst attached to a GO/SiO₂ support, wherein the GO/SiO₂ support has a weight ratio of GO:SiO₂ of greater than 1:5, and the GO comprises at least 25 mol. % oxygen (O) atoms,
or
wherein the GO/SiO₂ support has a weight ratio of GO:SiO₂ of ≤0.20, and the GO comprises at least 25 mol. % oxygen (O) atoms.

2. The supported Z-N catalyst of claim 1, wherein the GO:SiO₂ weight ratio is between 1:10 to 1:50.

3. The supported Z-N catalyst of claim 1, wherein the GO comprises 25 mol. % to 50 mol. % of oxygen atoms.

4. The supported Z-N catalyst of claim 1, wherein the Z-N/GO/SiO₂ catalyst is the reaction product of GO/SiO₂, a magnesium (Mg) compound, an electron donor compound, a compound comprising titanium, zirconium, or vanadium, and a halogen compound.

5. The supported Z-N catalyst of claim 4, wherein the Mg compound is magnesium chloride, Mg(C₄H₉)₂, dialkyl magnesium, alkyl, alkyl′ magnesium, alkyl alkoxy magnesium, dialkoxy magnesium, chloroalkoxy magnesium, chlorohydroxy magnesium, or any combination thereof.

6. The supported Z-N catalyst of claim 4, wherein the compound comprising titanium, zirconium, or vanadium is titanium tetrachloride, titanium ethoxide, titanocene dichloride, zirconium tetrachloride, zirconium ethoxide, zirconocene dichloride, vanadium tetrachloride, vanadium ethoxide, vanadocene, or any combination thereof.

7. The supported Z-N catalyst of claim 6, further comprising trimethylaluminium.

8. The supported Z-N catalyst of claim 4, wherein the halogen compound is BCl₃, AlCl₃, SiCl₄ or PCl₅.

9. The supported Z-N catalyst of claim 4, wherein the electron donor compound is an ester, ether, ketone, or mixtures thereof.

10. The supported Z-N catalyst of claim 1, wherein the graphene oxide is exfoliated or partially exfoliated graphene oxide.

11. A method of producing the supported Z-N catalyst of claim 1, the method comprising:
(a) mixing graphene oxide (GO) with silica (SiO₂) in a weight ratio of greater than 1:5 to form a GO/SiO₂ mixture;
(b) dispersing the GO/SiO₂ mixture in a liquid to form a dispersion; and
(c) reacting the dispersion with a reactant mixture of magnesium compound, an electron donor compound, a halogen compound, and a compound comprising titanium, zirconium, or vanadium under conditions sufficient to produce the Z-N/GO/SiO₂ catalyst.

12. The method of claim 11, wherein the reactions conditions comprise a temperature of 15 to 120° C. and/or a time of 60 min.

13. The method of claim 10, wherein the step (c) reactant mixture is obtained by solubilizing the magnesium compound, the halogen compound, the titanium compound in the electron donor compound.

14. The method of claim 10, further comprising isolating the catalyst and drying the catalyst at 25 to 45° C. under a flow of inert gas.

15. A method of polymerising an alpha-olefin, the method comprising: contacting an activated Z-N/GO/SiO₂ catalyst with gaseous reactant mixture comprising an alpha-olefin and hydrogen (H₂) under conditions sufficient to polymerise the alpha-olefin, wherein the Z-N/GO/SiO₂ catalyst is the Z-N/GO/SiO₂ catalyst of claim 1.

16. The method of claim 15, wherein the Z-N/GO/SiO₂ catalyst is activated by contacting the Z-N/GO/SiO₂ catalyst with an aluminium compound.

17. A method of polymerising an alpha-olefin, the method comprising: contacting an activated Z-N/GO/SiO₂ catalyst with gaseous reactant mixture comprising an alpha-olefin and hydrogen (H₂) under conditions sufficient to polymerise the alpha-olefin.
